(19) United States
(12) Patent Application Publication
(10) Pub. No.: US 2007/0295577 A1
(43) Pub. Date: Dec. 27, 2007

(54) Friction member and method of manufacturing thereof

(75) Inventors: Hiroshi Idei, Tokyo (JP); Katsuhiro Kikuchi, Tokyo (JP); Shou Kurihara, Tokyo (JP); Hisao Kamii, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AKEBONO BRAKE INDUSTRY CO., LTD.

(21) Appl. No.: 11/798,799

(22) Filed: May 17, 2007

(30) Foreign Application Priority Data
Jun. 26, 2006 (JP) 2006-175155

(51) Int. Cl. F16D 13/60

(52) U.S. Cl. 192/107 M; 192/107 C

(57) ABSTRACT

A friction member is manufactured by: a cleaning step of cleaning a pressure plate of a friction member; a shooting step of shooting a shot material having a predetermined particle diameter under a dry condition to a surface of the pressure plate; an adhesive application step of applying a powder adhesive on the surface of the pressure plate; and a forming treatment step of bonding a pre-formed product of a friction material to the surface of the pressure plate.

This application claims foreign priority from Japanese Patent Application No. 2006-175155, filed on Jun. 26, 2006, the entire contents of which are hereby incorporated by reference.

### BACKGROUND OF THE INVENTION

1. Field of the Invention

The present invention relates to a method of manufacturing a friction member to be used in automobiles, industrial machines, and the like.

2. Related Art

In a conventional method of manufacturing a friction member used in brakes and clutches for automobiles, industrial machines, and the like, a primer treatment is subjected on a surface of a pressure plate which had been subjected to a degreasing treatment, a cleaning treatment, and a drying treatment. An adhesive is applied after the primer treatment, and then a forming treatment is carried out by applying heat.

As the conventional method of manufacturing a friction member, JP-A-2002-322583 describes a surface treatment of a back metal (pressure plate) of a friction member by subjecting the back metal to a degreasing treatment with an aqueous alkali solution and a blast processing treatment for roughening the surface, wherein sludge and gel formation is not induced without generation of rust on the back metal by using at least one kind of phosphate salts or carbonate salts as an alkali for the aqueous alkali solution.

Moreover, JP-A-2002-048174 describes that a friction member is obtained by employing either one or both of surface conditioning with a surface conditioner prior to a formation step of a chemically treated film of a metal phosphate salt and use of a liquid for chemical conversion to which a reaction modifier is added in a chemically treated film formation step.

In the conventional method of manufacturing a friction member, a pressure plate is subjected to a chemical treatment with a phosphate salt or the like and hence there arises a problem of environmental burden such as treatment of waste water and sludge-burying disposal associated with discharged water from steps of renewal of liquid for chemical conversion, washing with water, and washing with hot water. In order to solve such a problem of the environmental burden, the present inventors have found a method for forming a ceramic thin film by dipping a pressure plate in a ceramic precursor solution, drawing it up, and heating it. According to the method, a friction member can be produced without subjecting to the chemical treatment. However, since the method requires a wet treatment using the ceramic precursor solution, there are a storage and preservation problem derived from short lifetime of the solution and an environmental hygiene problem of gas and smell generation.

Moreover, in the conventional method of manufacturing a friction material and the above method for forming a ceramic thin film, the primer treatment is generally conducted prior to the application of an adhesive. Adhesiveness of the adhesive can be improved by the primer treatment. However, since a liquid primer is applied in the primer treatment, it is necessary to dry the primer agent after the application of the primer agent. Furthermore, since in the primer treatment a thin film of a primer layer is formed on a surface of a pressure plate with the primer agent and the adhesive is applied thereon, there is a concern that the primer layer per se is peeled off the pressure sheet. Therefore, it is desired to develop a method of manufacturing a friction member, which can secure quality equal to or higher than that of the conventional friction members without the primer treatment.

### SUMMARY OF THE INVENTION

One or more embodiments of the invention provide a method of manufacturing a friction member, which reduces an environmental burden owing to no chemical treatment, results in stable film formation and adhesion quality, and also can secure quality equal to or higher than that of the conventional friction members without any primer treatment.

In accordance with one or more embodiments of the invention, a method of manufacturing a friction member is provided with:

a cleaning step of cleaning a pressure plate of a friction member,

a shooting step of shooting a shot material having a predetermined particle diameter under a dry condition to the surface of the pressure plate subjected to the cleaning step,

an adhesive application step of applying a powder adhesive on the surface of the pressure plate subjected to the shooting step, and

a forming treatment step of bonding a pre-formed product of a friction material to the surface of the pressure plate subjected to the adhesive application step to carrying out a forming treatment.

According to the method, since any chemical treatment of a pressure plate is not conducted, an environmental burden can be reduced. Moreover, since a shot material is shot in a dry state and a powder adhesive is applied, the environmental hygiene problem and the problem of storage and preservation of a solvent can be solved owing to no use of a solvent or the like and also a method of manufacturing a friction material with a stable adhesion quality. Furthermore, according to the method, since a surface of the pressure plate is roughened with the shot material and then an adhesive is directly applied on a film formed with the shot material, the primer treatment can be omitted and a concern that the primer layer per se is peeled off the pressure plate can be overcome, so that adhesiveness is improved and the quality is stabilized. Namely, quality equal to or higher than that of the conventional friction members can be secured.

In the cleaning step, the pressure plate of the friction member is cleaned. The friction member is, for example, a brake pad. In this connection, the friction member is not limited to the brake pad, but the friction member may be a brake shoe, a clutch plate, or the like.

The above cleaning step may be provided with a degreasing treatment of removing oily matter on the above pressure plate and a drying treatment of drying the pressure plate subjected to the degreasing treatment. In the degreasing treatment, lubricating oil and antirust oil attached during pressing and other processing of the pressure plate are removed. The removal of the oily matter attached to the pressure plate can be effected with an organic solvent such as acetone but the use of an aqueous degreasing solution is preferred. In this connection, as a method for cleaning the pressure plate, washing with hot water can be exemplified. In the drying treatment, the pressure plate after cleaning is dried in a constant-temperature furnace.

In the shooting step, a shot material having a predetermined particle diameter is shot under a dry condition to the surface of the above pressure plate subjected to the above cleaning step. By shooting the shot material, fine recesses and projections can be formed on the surface of the pressure plate. Moreover, a film having a predetermined thickness can be formed by attaching the shot material on the surface of the pressure plate. The formation of the fine recesses and projections on the surface of the pressure plate increases an adhesion area and, as a result, adhesiveness with the powder adhesive is improved. Furthermore, the shooting under a dry condition allows omission of the drying treatment which is required in the primer treatment. In the shooting of the shot material under a dry condition, the shot material is shot by means of compressed air, for example. In the shooting, the kind of the shot material, shooting rate, shooting angle, shooting amount, and the like are preferably designed in consideration of material properties of the pressure plate, particularly hardness and the like.

In the adhesive application step, a powder adhesive is applied on the surface of the above pressure plate subjected to the above shooting step. More specifically, the application of the powder adhesive on the surface of the pressure plate means application of the powder adhesive on the film formed on the surface of the pressure plate. Namely, in view of applying an adhesive directly on the surface of the pressure plate without any intervening primer layer, the method of manufacturing a friction member of the invention is different from the conventional methods of manufacturing a friction member. In this connection, a phenol resin is exemplified as the powder adhesive.

In the forming treatment step, a pre-formed product of a friction material which has been separately pre-formed is overlaid on the surface of the above pressure plate subjected to the above adhesive application step and a forming treatment is conducted. Thereby, a friction member where the friction material and the pressure plate is integrated can be formed. In this connection, the forming treatment is preferably conducted by applying heat and thereby, the integrity of the friction material and the pressure plate can be further enhanced. The friction material is obtained by mixing raw materials for the friction material in a predetermined formulation ratio and pre-forming the mixture by pressurization to form a plate-like material. As the raw materials for the friction material, use can be made of conventionally commonly used ones, e.g., a powder of a metal such as iron, aluminum, zinc, or the like, non-asbestos fiber such as steel fiber, aramide fiber, or ceramic fiber, a solid lubricant such as graphite or molybdenum disulfide, an organic friction modifier such as rubber dust or cashew dust, an abrasive such as zirconia, magnesia, or silicon carbide, a filler such as barium sulfate or calcium carbonate, a binder such as a phenol resin, and the like.

Moreover, in the method of manufacturing a friction member according to one or more embodiments, the above shooting step may be a step of shooting a shot material having a particle diameter of 100 to 200 μm under a pressure of 0.3 to 0.5 MPa in a direction approximately orthogonal to the surface of the above pressure plate subjected to the above cleaning step.

The particle diameter of the shot material governs the shape of the fine recesses and projections formed on the surface of the pressure plate, i.e., surface roughness. In the method, the thickness of the film is preferably from 20 to 30 μm. Moreover, the surface roughness of the surface of the pressure plate is preferably an arithmetic average roughness (Ra) value of 2 to 3 μm. Furthermore, in order to form such surface roughness and film, the particle diameter of the shot material is preferably from 100 to 200 μm, more preferably 150 μm. By shooting the shot material having a particle diameter of 100 to 200 μm in a direction approximately orthogonal to the surface of the pressure plate, a film having fine recesses and projections can be formed. In addition, by adjusting the pressure at the shooting to 0.3 to 0.5 MPa, a film having fine recesses and projections can be effectively formed.

The shooting of the shot material in the above shooting step is preferably conducted at a flow rate of the above shot material of 10 to 20 g/min for a shooting time of 50 to 70 sec. By the shooting under the above conditions in addition to the above-mentioned conditions of particle diameter, pressure, and the like, a film having a thickness of 20 to 30 μm can be more effectively formed, wherein fine recesses and projections on the surface of the film have an arithmetic average roughness (Ra) value of 2 to 3 μm.

Moreover, in the method of manufacturing a friction member according to one or more embodiments, the above shot material is preferably a ceramic having hardness higher than that of the above pressure plate. As mentioned above, the shooting is preferably designed in consideration of the kind of the shot material and the like and consideration of the particle diameter and hardness of the shot material is very important. In the method, since the pressure plate per se is a material having a high hardness, a stable film can be formed when a ceramic shot material having a high hardness is employed. As the ceramic shot material, alumina, silicon carbide, and the like can be exemplified.

Furthermore, in the method of manufacturing a friction member according to one or more embodiments of the invention, the above adhesive application step may comprise an electrostatic coating of a powder adhesive having a particle diameter of 20 to 30 μm on the surface of the above pressure plate subjected to the above shooting step.

When the application of an adhesive is conducted by electrostatic coating with a powder adhesive, the powder adhesive can be uniformly attached to the surface of the film on which fine recesses and projections have been formed. Thereby, adhesiveness is improved and the friction material can be surely attached to the surface of the pressure plate. The electrostatic coating is effected by applying a charged powder adhesive to the earthed pressure plate. Incidentally, the film on the surface of the pressure plate formed by the shooting as mentioned above functions as an underlying layer for the adhesive through the application of the powder adhesive.

The particle size of the shot material is preferably determined based on the surface roughness of the film and the fine recesses and projections formed on the surface but can be determined in consideration of the particle diameter of the powder adhesive. Specifically, by making the diameter of the shot material larger than the particle diameter of the powder adhesive, fine recesses and projections having a curved surface larger than the curved surface of the powder adhesive can be formed. As a result, the powder adhesive can be effectively applied, i.e., adhered to the curved surface that forms the fine recesses and projections.

Moreover, in the method of manufacturing a friction member according to one or more embodiments of the invention, the above forming treatment step may comprise a pre-heating treatment of heating the above pressure plate subjected to the above adhesive application step at a temperature of 100 to 140° C., a thermal forming treatment of applying heat at 130 to 200° C. to the above pressure plate subjected to the above pre-heating treatment and a pre-formed product of the above friction material under a pressure of 20 to 100 MPa, and a heating treatment of applying heat at 150 to 300° C. for 1 to 15 hours to the above friction member where the above pressure plate is bonded to the pre-formed product of the above friction material.

In the pre-heating treatment, heat at 100 to 140° C. is applied to the above pressure plate subjected to the above adhesive application step. At the application of heat may be performed in such a state that the above pre-formed product of the friction material is overlaid on the above pressure plate subjected to the above adhesive application step. The time for applying heat may be from about 5 to 15 minutes. By conducting the pre-heating treatment, the adhesive applied in the adhesive application step can be converted into a flow state before curing and thus permeation of the adhesive into a porous part of the friction material is facilitated. As a result, increase in adhesion strength of the friction material is promoted.

In the thermal forming treatment step, heat at 130 to 200° C. is applied to the above pressure plate subjected to the above pre-heating treatment and the pre-formed product of the above friction material under a pressure of 20 to 100 MPa. Thereby, the friction material is subjected to compression molding into final thickness and the friction material and the pressure plate are bonded to each other. Moreover, in the heating treatment, heat at 150 to 300° C. is applied for 1 to 15 hours to the above pressure plate to which the friction material has been bonded. The heating treatment is also referred to as “after-cure” and curing of the binder and the adhesive is effected by the heating treatment, whereby the strength of the friction material is improved. Moreover, according to the heating treatment, the adhesion strength between the pressure plate and the friction material can be improved.

According to the invention, there can be provided a method of manufacturing a friction member, which reduces an environmental burden owing to no chemical treatment, results in stable film formation and adhesion quality, and also can secure quality equal to or higher than that of the conventional friction members.

Other aspects and advantages of the invention will be apparent from the following description and the appended claims.

### BRIEF DESCRIPTION OF THE DRAWINGS

FIG. 1 is a flow diagram showing a method of manufacturing a friction member according to a first exemplary embodiment.

FIG. 2 is a drawing showing a state of shooting a shot material 1 to the pressure plate 10.

FIG. 3 is one example of a method of manufacturing a friction member in a conventional art.

FIG. 4 is a drawing showing shear test results.

### DETAILED DESCRIPTION OF THE EXEMPLARY EMBODIMENTS

Exemplary embodiments of the invention will be described with reference to drawings. In the exemplary embodiments, a case of manufacturing a pressure plate for brake pads of automobiles is described as an example. However, the method of manufacturing a friction member according to the invention is not limited to the exemplary embodiments.

### <Method for Adhesion>

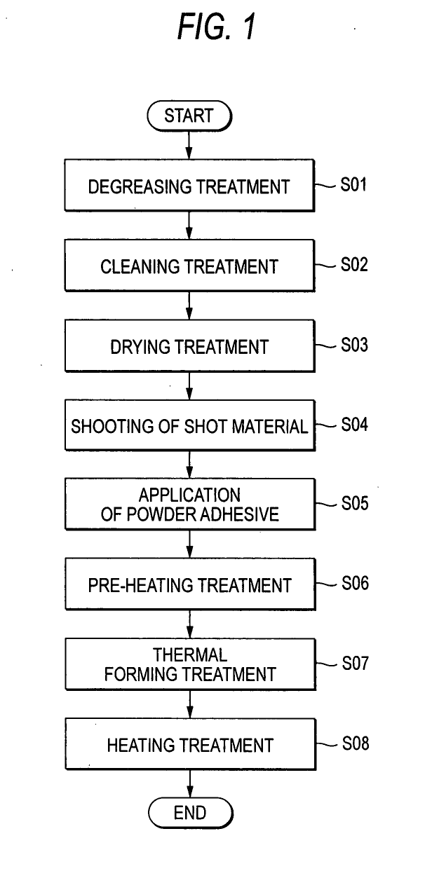

FIG. 1 is a flow chart showing the method of manufacturing a friction member according to a first exemplary embodiment. In Step S01, a pressure plate 10 for brake pads is subjected to a degreasing treatment. The pressure plate 10 can be obtained by a sheet-metal pressing step. In the degreasing treatment, lubricating oil and antirust oil attached to the surface of the pressure plate 10 during the sheet-metal pressing step are removed with a water-soluble degreasing solution.

In Step S02, the pressure plate 10 subjected to the degreasing step is cleaned. Specifically, the pressure plate 10 is washed with hot water. In Step S03, the pressure plate 10 after cleaning is dried. Specifically, the pressure plate 10 after cleaning is dried in a drying furnace at a temperature of 80° C. for about 1 to 2 minutes.

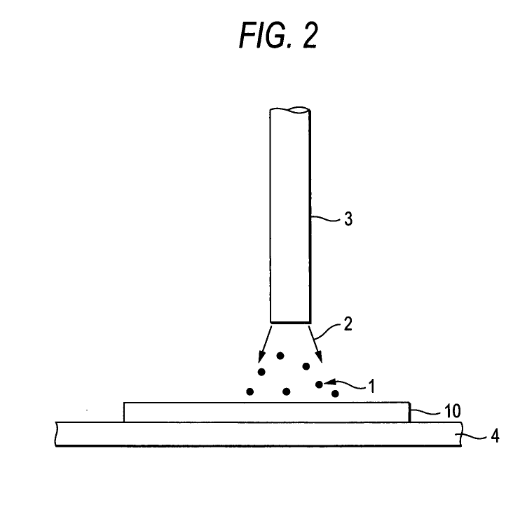

In Step S04, a shot material 1 is shot to the pressure plate 10. FIG. 2 is a drawing showing a state of shooting the shot material 1 to the pressure plate 10. As shown also in the figure, in the first exemplary embodiment, the shot material 1 composed of alumina having a particle diameter of 150 μm is shot to a surface of the pressure plate 10 in a vertical direction under a pressure of 0.3 to 0.5 MPa from a nozzle 3 having a diameter of 1.2 mm using dry air as a carrier gas 2. Incidentally, in the first exemplary embodiment, the shooting is conducted at a flow rate of the shot material 1 at the shooting is from 10 to 20 g/min and a shooting time of 60 sec. Thereby, on the surface of the pressure plate 10, there is formed a film having a thickness of 25 μm and fine recesses and projections thereon whose value of arithmetic average roughness (Ra) is from 2 to 3 μm. The numeral 4 means a conveyer for conveying the pressure plate 10.

In Step S05, a powder adhesive is applied on the surface, more specifically the film of the pressure plate 10. Specifically, a phenol resin-based powder adhesive having a particle diameter of 25 μm is statistically applied on the surface of the pressure plate 10 by a corona charging method. Namely, a charged powder adhesive is applied on the surface of the earthed pressure plate 10. After the application of the powder adhesive, the applied plate is heated under a temperature of 130° C. for about 15 minutes to form an adhesive layer having a thickness of 30 to 40 μm.

In Step S06, a pre-formed product of a friction material is overlaid on the adhesive layer of the pressure plate 10, which is then subjected to a pre-heating treatment. More specifically, heat at about 100 to 140° C. is applied for 5 to 15 minutes in a state of overlaying the pre-formed product of the friction material and the pressure plate 10. Thereby, the adhesive can be converted into a flow state before curing.

In Step S07, the pressure plate 10 subjected to the pre-heating is subjected to a thermal forming treatment. More specifically, heat at 130 to 200° C. is applied to the pressure plate 10 subjected to the pre-heating treatment and the pre-formed product of the friction material under a pressure of 20 to 100 MPa. Thereby, forming of the friction material and adhesion of the friction material and the pressure plate can be conducted at the same time.

In Step S08, there is conducted a heating treatment (after-cure) of the pressure plate 10 where the thermal forming treatment has been completed. More specifically, heat at 150 to 300° C. is applied for 1 to 15 hours. Thereby, curing of the binder and the adhesive in the friction material is completed.

### <Comparison with Conventional Example>

Next, one example of the method of manufacturing a friction member according to the conventional art is described. Furthermore, the above-mentioned method of manufacturing a friction member according to the first exemplary embodiment is explained in comparison with the method of manufacturing a friction member according to the conventional art.

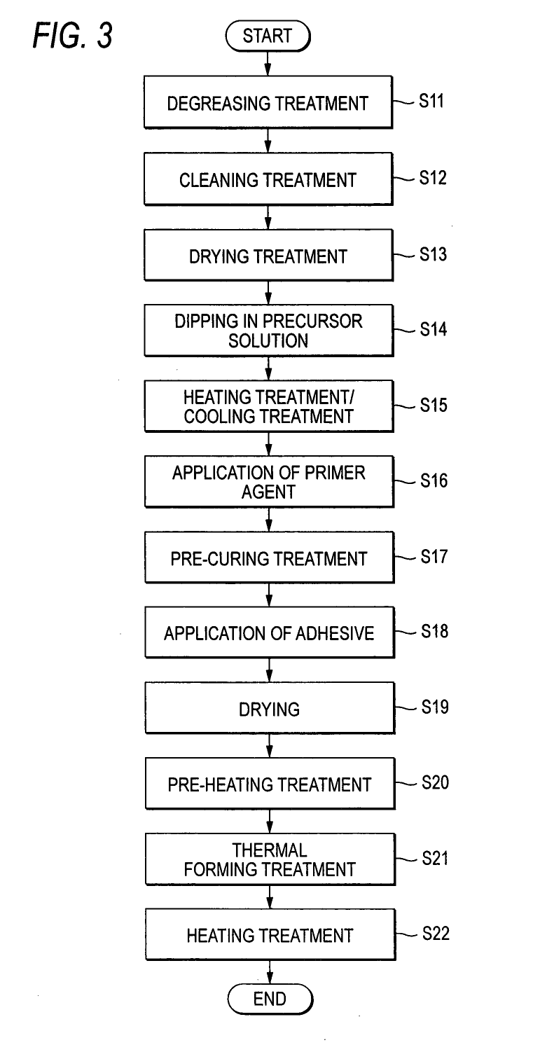

FIG. 3 is one example of the method of manufacturing a friction member according to the conventional art. First, in Step S11 to Step S13, a degreasing treatment, a cleaning treatment, and a drying treatment of a pressure plate are conducted. In this connection, the degreasing treatment, cleaning treatment, and drying treatment can be conducted in the same procedures as in Step S01 to Step S03 described in the method of manufacturing a friction member according to the first exemplary embodiment. Therefore, detailed description thereof is omitted.

In Step S14, the pressure plate is dipped in a ceramic precursor solution. The ceramic precursor solution is prepared by mixing triethoxymethylsilane and acetic acid in a molar ratio of 1:4 with ethanol as a solvent to dissolve them, adding polyvinylbutyral in a ratio of 5 wt % in a film, and heating the whole at a temperature of 70° C. for 3 hours to concentrate it so as to be 1 mol/l.

In Step S15, the pressure plate dipped in the precursor is drawn up at a constant rate of 800 mm/min and then heated at a temperature of 150° C. for 3 hours. Thereby, a film having a thickness of 500 to 1000 nm is formed on the surface of the pressure plate. Thereafter, the plate is cooled for a predetermined time and then an iron phosphate film is further formed and a primer treatment is conducted, that is, a primer agent is applied on the iron phosphate film (Step S16). In this connection, the iron phosphate film had a film weight of 0.4 to 0.8 g/m². Moreover, a phenol-based resin was used as a primer agent and the thickness of the primer layer was from 5 to 20 μm.

In Step S17, the pressure plate subjected to the primer treatment is subjected to a pre-curing treatment. Then, in Step S18, an adhesive is applied. As the adhesive, a thermosetting adhesive was used. In Step S19, the pressure plate after the application of the adhesive is dried. After drying of the pressure plate, a heating treatment, a thermal forming treatment, and a heating treatment of the pressure plate are conducted in Step S20 to Step S22. In this connection, the pre-heating treatment, thermal forming treatment, and thermal curing treatment can be conducted in the same procedures as in Step S06 to Step S08 described in the method of manufacturing a friction member according to the first exemplary embodiment. Therefore, detailed description thereof is omitted.

When the method of manufacturing a friction member according to the conventional art and the method of manufacturing a friction member according to the first exemplary embodiment described in the above are compared, the method of manufacturing a friction member according to the conventional art comprises a chemical treatment of forming an iron phosphate film and also a primer treatment. However, in the method of manufacturing a friction member according to the first exemplary embodiment, since the chemical treatment and the primer treatment are not conducted, a solvent or the like required in the chemical treatment and the primer treatment is not used, so that an environmental burden such as renewal of a liquid for chemical conversion and washing with water can be reduced.

Moreover, in the method of manufacturing a friction member according to the first exemplary embodiment, since no solvent is used and the shot material is shot under a dry condition, there arise no problem of storage and preservation of a solution. Also, the influence of smell on workers is diminished and thus safety of the workers can be secured as well as an environmental hygiene problem can be reduced.

Furthermore, in the method of manufacturing a friction member according to the first exemplary embodiment, the adhesion of the friction material is achieved without any primer treatment that is hitherto required and hence the number of steps is reduced. Thereby, the method of manufacturing a friction member according to the first exemplary embodiment can realize reduction of equipment expenses, space-saving, and reduction of running costs.

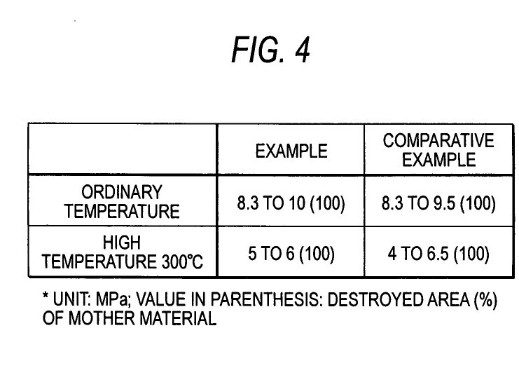

In addition, since the brake pad produced by the method of manufacturing a friction member according to the first exemplary embodiment does not have a primer layer, peeling-off that is a concern of a brake pad having a primer layer is inhibited and adhesiveness is improved, so that the quality is stabilized. Namely, quality equal to or higher than that of the conventional friction members can be secured. FIG. 4 is a drawing showing shear test results on the brake pad produced by the method of manufacturing a friction member according to the first exemplary embodiment and the brake pad produced by the method of manufacturing a friction member according to the conventional art. In this connection, the present test was carried out based on JASO Standards.

As shown in FIG. 4, under each of the conditions of ordinary temperature and high temperature, it was confirmed that the brake pad produced by the method of manufacturing a friction member according to the first exemplary embodiment (present example) has shearing force equal to that of the brake pad produced by the method of manufacturing a friction member according to the conventional art (conventional example). Thus, according to the method of manufacturing a friction member according to the first exemplary embodiment, there can be provided a brake pad having quality equal to that of conventional one, even when no primer treatment is conducted.

It will be apparent to those skilled in the art that various modifications and variations can be made to the described embodiments of the present invention without departing from the spirit or scope of the invention. Thus, it is intended that the present invention cover all modifications and variations of this invention consistent with the scope of the appended claims and their equivalents.

What is claimed is:

1. A method of manufacturing a friction member comprising:
a cleaning step of cleaning a pressure plate of a friction member;
a shooting step of shooting a shot material under a dry condition to a surface of the pressure plate subjected to the cleaning step;
an adhesive application step of applying a powder adhesive on the surface of the pressure plate subjected to the shooting step; and
a forming treatment step of bonding a pre-formed product of a friction material to the surface of the pressure plate subjected to the adhesive application step to carrying out a forming treatment.

2. The method according to claim 1, wherein the shot material has a particle diameter of 100 to 200 μm, and
the shot material is shot under a pressure of 0.3 to 0.5 MPa in a direction substantially orthogonal to the surface of the pressure plate, in the shooting step.

3. The method according to claim 1, wherein the shot material is a ceramic having a hardness harder than a hardness of the pressure plate.

4. The method according to claim 3, wherein the powder adhesive has a particle diameter of 20 to 30 μm, and
the powder adhesive is applied on the surface of the pressure plate by an electrostatic coating, in the adhesive application step.

5. The method according to claim 1, wherein the forming treatment step comprises:
a pre-heating treatment of heating the pressure plate subjected to the adhesive application step at a temperature of 100 to 140° C.;
a thermal forming treatment of applying heat at 130 to 200° C. to the pressure plate subjected to the pre-heating treatment and a pre-formed product of the friction material under a pressure of 20 to 100 MPa; and
a heating treatment of applying heat at 150 to 300° C. for 1 to 15 hours to the friction member where the pressure plate is bonded to the pre-formed product of the friction material by the thermal forming treatment.

6. A friction member obtained by integrally forming a pressure plate and a friction material, the friction member comprising:
a pressure plate;
a shot material layer formed by shooting a shot material under a dry condition to a surface of the pressure plate;
an adhesive layer formed by applying a powder adhesive on the shot material layer; and
a friction material bonded on the surface of the pressure plate which is provided with the adhesive layer.

7. The friction member according to claim 6, wherein the shot material layer comprises a ceramic layer having a thickness of 20 to 30 μm.
